(19) United States
(12) Patent Application Publication
(10) Pub. No.: US 2016/0290931 A1
(43) Pub. Date: Oct. 6, 2016

(54) CONTENT CONDITION DETERMINATION APPARATUS AND CONTENT CONDITION DETERMINATION METHOD

(71) Applicant: TSUBAKIMOTO CHAIN CO., Osaka (JP)

(72) Inventor: Hiroyuki Taike, Osaka (JP)

(73) Assignee: TSUBAKIMOTO CHAIN CO., Osaka (JP)

(21) Appl. No.: 15/081,448

(22) Filed: Mar. 25, 2016

(30) Foreign Application Priority Data
Mar. 31, 2015 (JP) 2015-073349

(51) Int. Cl. G01N 21/88

(52) U.S. Cl. CPC G01N 21/8806

(57) ABSTRACT

An object of the present invention is to provide a content condition determination apparatus and a content condition determination. Method capable of efficiently determining the conditions of contents in drug-discovery storage tubes a short time using a simple configuration. A content condition determination apparatus includes a tube moving mechanism 120 that moves drug-discovery storage tubes MT to an imaging position, a lighting unit 130 that projects transmitted light, and a control section 150 that controls processing and operation of an imaging unit 110, an image processing section 140, the tube moving mechanism 120, and the lighting unit 130. The lighting unit 130 has an infrared light projection section 131. The control section 150 is configured to allow the light projection the lighting unit 130 and the imaging by the imaging unit 110 to be performed in an interlocking manner.

### BACKGROUND OF THE INVENTION

1. Field of the Invention

The present invention relates to a content condition determination apparatus and a content condition determination method for determining the conditions of contents in drug-discovery storage tubes.

2. Description of the Related Art

In the field of drug discovery research, experiments in which a large number of samples are stored and analyzed at low temperature need to be efficiently conducted.

Thus, for example, as depicted in FIG. 4, a solution in which a sample is dissolved is injected into small cylindrical or square-tubular containers (drug-discovery storage tubes) called microtubes MT. The microtubes MT are housed in tandem in a storage plate R that is compliant with Society for biomolecular screening (SBS) standards and that has 8×12 partitions, that is, a total of 96 partitions. The microtubes MT are stored and transferred with openings thereof sealed with removable caps C.

The conditions of the contents in the microtubes MT, such as the amount and the dissolution condition, are very important for experiments. Thus, the conditions need to be checked before storage. However, the storage plate R, in which a large number of microtubes MT are housed, has partitions arranged at a small pitch in the above-described example. Therefore, determining the conditions of the contents in the microtubes MT housed in the storage plate R has been difficult.

Thus, the microtubes MT need to be manually unloaded one by one and visually checked, and considerable amounts of time and effort have been needed to determine the conditions of all the microtubes MT.

The visual check further demands very high attentiveness and concentration of operators depending on the transparency and color of the microtubes MT and the color of the solution, increasing the possibility of errors when checking. Missing detective samples may affect accuracy and reliability of the experiments.

Thus, apparatuses, which optically detect foreign matter in the solution using a sensor or the like, are well known (see, for example, Japanese Patent Application Laid-open No. 2003-107010). The use of such an apparatus is expected to increase the accuracy of determination.

### SUMMARY OF THE INVENTION

Well-known foreign-matter detection apparatuses can detect relatively large foreign matter in transparent containers. The apparatus in Japanese Patent Application Laid-open No. 2003-107010 uses light in different colors or reflected light and transmitted light to detect foreign matter and to discriminate foreign matter to be excluded from acceptable foreign matter.

However, when, like drug-discovery storage tubes, the containers are very small and contain a very small amount of sample, achieving accurate determination using the well-known foreign-matter detection apparatus is difficult. Moreover, if the solution has a dark color and contains foreign matter in the same color, undissolved turbid matter, precipitates, or the like, the conditions including the presence or absence of the solution may be difficult to check.

The present invention solves these problems. An object of the present invention is to provide a content condition determination apparatus and a content condition determination method capable of efficiently determining the conditions of contents in drug-discovery storage tubes in a short time using a simple configuration.

A content condition determination apparatus according to the present invention includes an imaging unit and an image processing section to determine conditions of contents in drug-discovery storage tubes. The content condition determination apparatus includes a tube moving mechanism that moves the drug-discovery storage tubes to an imaging position, a lighting unit that projects transmitted light on the drug-discovery storage tubes, and a control section that controls processing and operation of the imaging unit, the image processing section, the tube moving mechanism, and the lighting unit. The lighting unit has an infrared light projection section. The control section is configured to allow the light projection by the lighting unit and the imaging by the imaging unit to be performed in an interlocking manner on the drug-discovery storage tubes stopped at the imaging position after being unloaded by the tube moving mechanism.

A content condition determination method according to the present invention determines conditions of contents in drug-discovery storage tubes using an imaging unit and an image processing section. The content condition determination method includes moving the drug-discovery storage tubes to an imaging position, projecting infrared transmitted light on the drug-discovery storage tubes and imaging the drug-discovery storage tubes by the imaging unit, and determining, by the image processing section, the conditions of the contents in the drug-discovery storage tubes based on an image taken by the imaging unit.

in the content condition determination apparatus in a first aspect, the lighting unit has the infrared light projection section, and the control section allows the light projection by the lighting unit and the imaging by the imaging unit to be performed in an interlocking manner on the drug-discovery storage tubes stopped at the imaging position after being unloaded by the tube moving mechanism. Thus, even when the solution has a dark color and contains foreign matter in the same color, undissolved turbid matter, precipitates, or the like, solids such as the foreign matter and the turbid matter and the solution can be imaged in sharp contrast utilizing the characteristics of infrared rays.

Thus, the sizes and dispersion of the solids can be determined, allowing determination of the conditions of the contents including foreign matter, turbidity, and precipitation.

Under the control of the control section, the tube moving mechanism can automatically perform unloading of the drug-discovery storage tubes and stoppage of the drug-discovery storage tubes at the imaging position, enabling automation of light projection and imaging. This allows quick and efficient determination of the conditions of the contents in a large number of drug-discovery storage tubes housed in the storage plate.

in the configuration in a second aspect, the tube moving mechanism has the pushing section that pushes the drug-discovery storage tubes from below the storage plate to the imaging position, and the orientation holding section located opposite to the pushing section and coming into abutment with the drug-discovery storage tubes from above. The pushing section has the plurality of pushing pins erected in a line. The orientation holding section has the pressing member extending in the direction in which the pushing pins are arranged. Thus, a plurality of the drug-discovery storage tubes can be simultaneously moved from the storage plate to the imaging position with the orientations of the drug-discovery storage tubes maintained. This allows quicker and more efficient determination of the conditions of the contents.

In the configuration in a third aspect, the lighting unit further has the red visible-light projection section, and the control section is configured to switch the infrared flooding section and the red visible-light projection section of the lighting unit to allow two operations to be performed on the drug-discovery storage tubes stopped at the imaging position by the tube moving mechanism. Thus, the liquid surface of the solution, for which the contrast is reduced by infrared rays, can be discriminated using red visible light, allowing the conditions of the content to be more reliably determined.

In the configuration in a fourth aspect, the image processing section quantifies the liquid surface, turbidity, precipitates, suspended matter, and the like in the contents in the drug-discovery storage tubes, based on information obtained by the imaging performed twice by the imaging unit. Thus, determinations can be reliably made including determination of whether the content can be used as a reagent.

In the configuration in a fifth aspect, the lighting unit has a light emission control section that performs light projection only for a time needed for the imaging by the imaging unit. This substantially prevents the drug-discovery storage tubes from being heated, allowing the sample to be restrained from being modified by the heat of the solution and enabling the accuracy and reliability of experiments to be prevented from being affected.

The content condition determination method in a sixth aspect includes moving the drug-discovery storage tubes to the imaging position, projecting infrared transmitted light on the drug-discovery storage tubes and imaging the drug-discovery storage tubes by the imaging unit, and determining, by the image processing section, the conditions of the contents in the drug-discovery storage tubes based on the image taken by the imaging unit. Thus, even when the solution has color and contains foreign matter in the same color, undissolved turbid matter, precipitates, or the like, solids such as the foreign and the turbid matter and the solution can be imaged in sharp contrast utilizing the characteristics- of infrared rays.

Thus, the sizes and dispersion of the solids can be determined, allowing determination of the conditions of the contents including foreign matter, turbidity, and precipitation.

In the configuration in a seventh aspect, the projection of the infrared transmitted light on the drug-discovery storage tubes is switched to projection of transmitted light of red visible light, and the drug-discovery storage tubes is imaged twice by the imaging unit. The liquid surface, turbidity, precipitates, suspended matter, and the like in the contents in the drug-discovery storage tubes are quantified by the image processing section, based on images obtained by the imaging performed twice by the imaging unit.

In the content condition determination method in an eighth aspect, light projection is performed only for a time needed for the imaging by the imaging unit. Thus, the drug-discovery storage tubes are not substantially heated. Consequently, the sample can be restrained from being modified by the heat of the solution, and the accuracy and reliability of experiments can be prevented from being affected.

### BRIEF DESCRIPTION OF THE DRAWINGS

FIG. 1 is a schematic diagram of a content condition determination apparatus in the present invention;

FIG. 2 is a schematic perspective view of a content condition determination apparatus in an embodiment of the present invention;

FIG. 3 is a diagram illustrating a pressing member; and

FIG. 4 is a perspective view of an example of a storage plate and drug-discovery storage tubes.

### DESCRIPTION OF THE PREFERRED EMBODIMENT

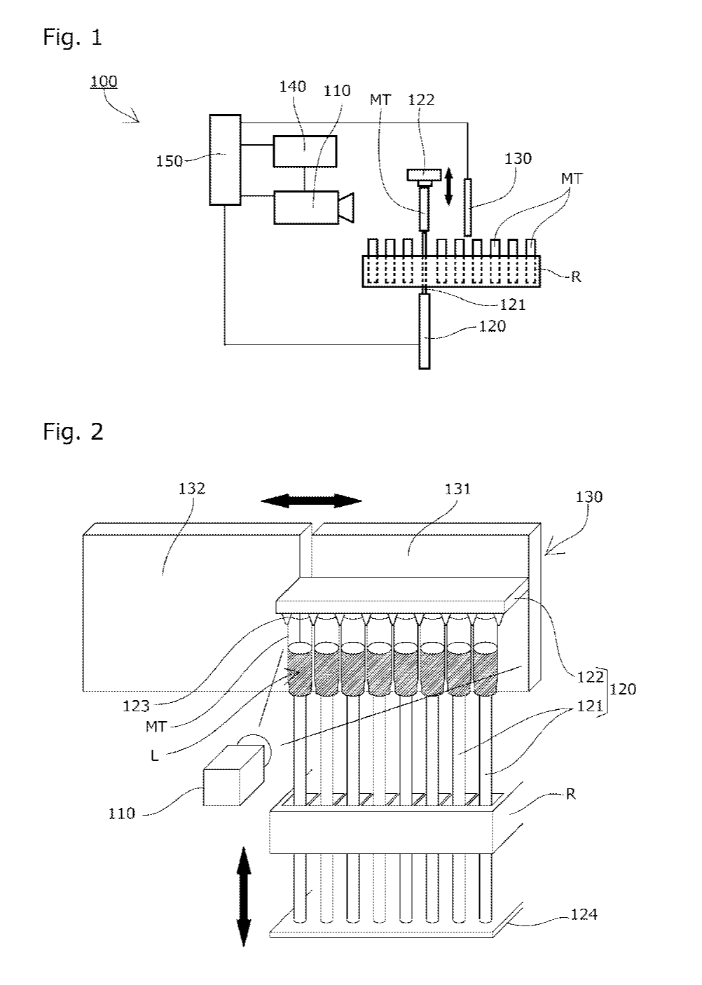

A content condition determination apparatus and a content condition determination method in the present invention will be described in brief based on FIG. 1.

A content condition determination apparatus 100 has an imaging unit 110 and an image processing section 140 to determine the conditions of contents in drug-discovery storage tubes MT.

A tube moving mechanism 120 has pushing pins 121 that is a pushing section pushing the drug-discovery storage tubes MT from below a storage plate R to an imaging position, and a pressing member 122 that is an orientation holding section located opposite to the pushing pins 121 and coming into abutment with the drug-discovery storage tubes MT from above.

A lighting unit 130 is provided opposite to the imaging unit 110 across the drug-discovery storage tubes MT at the imaging position to project the infrared transmitted light toward the imaging unit 110.

The drug-discovery storage tubes MT are housed in the storage plate R and placed below the imaging position. First, the pressing member 122 of the tube moving mechanism 120 comes into abutment with upper portions of the drug-discovery storage tubes MT.

Then, pushing pins 121 rise from below, and the drug-discovery storage tubes MT, sandwiched between the pressing member 122 and the pushing pins 121, move to the imaging position with the orientations of the drug-discovery storage tubes MT maintained.

With the drug-discovery storage tubes MT stopped at the imaging position, the lighting unit 130 emits light, and the imaging unit 110 picks up images using transmitted light. The image processing section 140 quantifies the liquid surface, turbidity, precipitates, suspended matter, and the like in the contents to determine the conditions of the contents.

The lighting unit 130 may be configured to enable switching between the infrared light projection section and a red visible-light projection section such that imaging is performed by the imaging unit for each light projection, and the liquid surface, turbidity, precipitates, suspended matter, and the like in the contents is quantified by the image processing section 140 based on information obtained by the imaging performed twice, whereby the conditions of the contents are determined.

The series of operations is controlled by a control section 150.

The control section 150 sets the time for light projection performed by the lighting unit lit 130, equal to the minimum time needed for imaging by the imaging unit 110, preventing the contents in the drug-discovery storage tubes MT from being thermally affected. Thus, the accuracy and reliability of experiments can be prevented from being affected.

Further, the tube moving mechanism 120 may grip and raise the drug-discovery storage tubes MT from above. As long as the orientations of the drug-discover storage tubes MT can be maintained when and after the drug-discovery storage tubes MT are stopped at the imaging position, the pushing section may be exclusively provided, and the pressing member 122, which is the orientation holding section, may be omitted.

The schematic diagram in FIG. 1 depicts only one drug-discovery storage tube MT. However, in the actual storage plate R, a plurality of the drug-discovery storage tubes MT is arranged in parallel in a front-back direction of the sheet of FIG. 1. The drug-discovery storage tubes MT may be simultaneously lifted up by the tube moving mechanism and then imaged.

In this case, imaging unit 110 may cover all the drug-discovery storage tubes MT so as to image all the drug-discovery storage tubes MT at once. The imaging unit 110 may move in the front-back direction of the sheet of FIG. 1 to perform imaging a plurality of times.

The light unit 130 may also have an enlarged light emission surface to simultaneously project light on all the drug-discovery storage tubes MT may move in the front-back direction of the sheet of FIG. 1 to perform light projection a plurality of times.

Switching between the infrared light projection section and the red visible-light projection section of the lighting unit 130 may be achieved such that a plurality of types of light sources is arranged on the same light emission surface and electrically switched to one another or is moved on different light emission surfaces.

The control section 150 need not be physical independent. Control functions embedded in the respective units may be appropriately linked to function as the control section 150 as a whole; for example, the image processing section 140 and the imaging unit 110 may control the lighting unit 130.

### EMBODIMENT

The content condition determination apparatus that is an embodiment of the present invention pushes the drug-discovery storage tube (microtubes) MT housed in tandem in the storage plate R with 8×12, that is, a total of 96 partitions, from below the storage plate R to the imaging position and image the drug-discovery storage tubes MT in column unit depicted in FIG. 2.

The tube moving mechanism 120 has eight pushing pins 121 that push the drug-discovery storage tubes MT from below the storage plate R to the imaging position, and the pressing member 122 located opposite to the pushing pins 121 and coming into abutment with the eight drug-discovery storage tubes MT from above.

The pushing pins 121 are fixed to a platform 124, which is elevated and lowered to simultaneously elevate and lower the eight pushing pins 121.

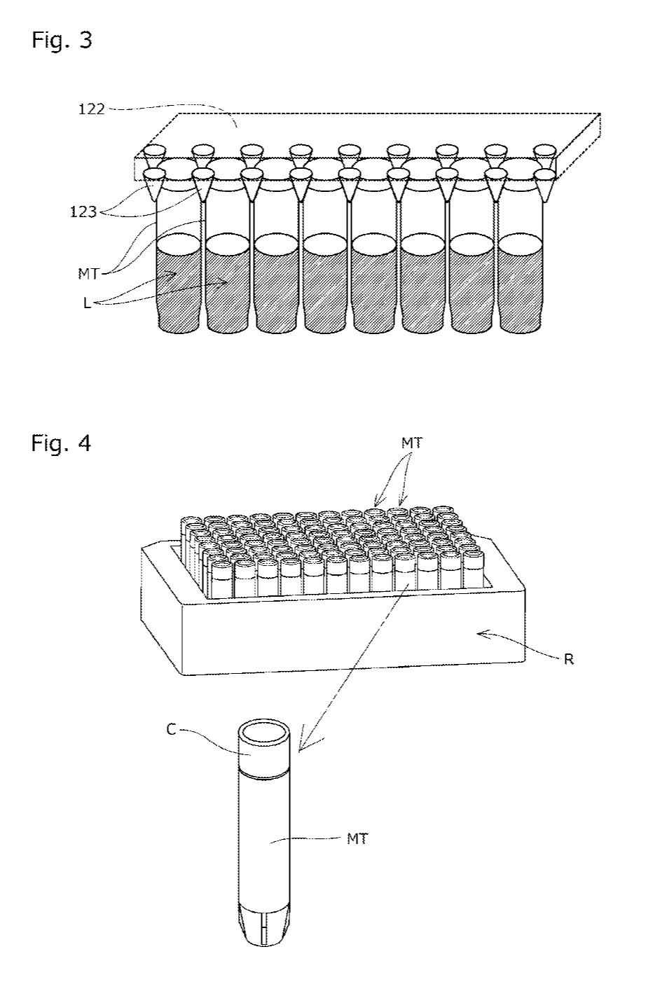

As depicted in FIG. 2 and FIG. 3, the pressing member 122 is provided, on a side thereof that comes into abutment with the drug-discovery storage tubes MT, with positioning pins 123 that come into abutment with upper peripheral portions of the respective drug-discovery storage tubes MT.

The positioning pins 123 are shaped like cones, and 9×2, that is, 18 positioning pins 123 are provided so as to come into abutment with each drug-discovery storage tube MT at four points.

Thus, when the pressing member 122 is lowered from above, the positioning pins 123 are smoothly inserted among the drug-discovery storage tubes MT and allow the drug-discovery storage tubes MT to be simultaneously positioned at a predetermined lowering position with respect to the pressing member 122.

Before the pushing pins 121 rise from below, the pressing member 122 performs an operation of positioning the drug-discovery storage tubes MT to raise the drug-discovery storage tubes MT, sandwiched between the pressing member 122 and the pushing pins 121, in conjunction with the rise of the gushing pins 121. Thus, the drug-discovery storage tubes MT can be raised to the imaging position with the orientations of the drug-discovery storage tubes MT maintained.

The lighting unit 130 has an infrared light projection section 131 and a red visible-light projection section 132 on a right side and a left side, respectively, of the unit 130. Switching between the infrared light projection section 131 and the red visible-light projection section 132 can be performed by sliding the infrared light projection section 131 and the red visible-light projection section 132 in a lateral direction.

The present embodiment is intended for the drug-discovery storage tubes MT housed in the storage plate R with 8×12, that is, a total of 96 partitions. However, the size, number, arrangement, and the like of the components may be designed, as appropriate, according to the size or shape of the drug-discovery storage tubes MT, the number of the partitions in the storage plate R, or the like as needed.

If the storage plate R is shaped to preclude the pushing pins from being inserted from below, a configuration for gripping and lifting may be provided on the pressing member side to stop operation of the pushing pins.

What is claimed is:

1. A content condition determination apparatus including an imaging unit, and an image processing section to determine conditions of contents in drug-discovery storage tubes, the content condition determination apparatus comprising:
a tube moving mechanism that moves the drug-discovery storage tubes to an imaging position;
a lighting unit that projects transmitted light on the drug-discovery storage tubes; and
a control section that controls processing and operation of the imaging unit, the image processing section, the tube moving mechanism, and the lighting unit,
wherein the lighting unit has an infrared light projection section, and
the control section is configured to al low the light projection by the lighting unit and the imaging by the imaging unit to be performed in an interlocking manner on the drug-discovery storage tubes stopped at the imaging position after being unloaded by the tube moving mechanism.

2. The content condition determination apparatus according to claim 1, wherein the tube moving mechanism has a pushing section that pushes the drug-discovery storage tubes from below a storage plate to the imaging position, and an orientation holding section located opposite to the pushing section and coming into abutment with the drug-discovery storage tube-, from above,
the pushing section has a plurality of pushing pins erected in a line, and
the orientation holding section has a pressing member extending in a direction in which the pushing pins are arranged.

3. The content condition determination apparatus according to claim 1, wherein the lighting unit further has a red visible-light projection section, and
the control section is configured to switch the infrared flooding section and the red visible-light projection section of the lighting unit to allow two operations to be performed on the drug-discovery storage tubes stopped at the imaging position by the tube moving mechanism.

4. The content condition determination apparatus according to claim 3, wherein the image processing section quantifies a liquid surface, turbidity, precipitates, suspended matter, and the like in the contents in the drug-discovery storage tubes, based on information obtained by the imaging performed twice by the imaging unit.

5. The content condition determination apparatus according to claim 1, wherein the lighting unit has a light emission control section that performs light projection only for a time needed for the imaging by the imaging unit.

6. A content condition determination method for determining conditions of contents in drug-discovery storage tubes using a content condition determination apparatus including an imaging unit, and an image processing section, the content condition determination method comprising:
moving the drug-discovery storage tubes to an imaging position;
projecting infrared transmitted light on the drug-discovery storage tubes and imaging the drug-discovery storage tubes by the imaging unit; and
determining, by the image processing section, the conditions of the contents in the drug-discovery storage tubes based on an image taken by the imaging unit.

7. The content condition determination method according to claim 6, wherein the projection of the infrared transmitted light on the drug-discovery storage tubes is switched to projection of transmitted light of red visible light, and the drug-discovery storage tubes is imaged twice by the imaging unit, and
a liquid surface, turbidity, precipitates, suspended matter, and the like in the contents in the drug-discovery storage tubes are quantified by the image processing section, based on images obtained by the imaging performed twice by the imaging unit.

8. The content condition determination method according to claim 6, wherein light projection is performed only for a time needed for the imaging by the Imaging unit.
